(19) United States
(12) Patent Application Publication
(10) Pub. No.: US 2009/0249380 A1
(43) Pub. Date: Oct. 1, 2009

(54) Suspension Arm Actuator for a Scanning Device

(76) Inventors: Michael Bammert, Hardt (DE); Tsuneo Suzuki, Moenchweiler (DE); Rolf Dupper, Villingen-Schwenningen (DE)

Correspondence Address: Thomson Licensing LLC, P.O. Box 5312, Two Independence Way, PRINCETON, NJ, 08543-5312, US

(21) Appl. No.: 12/227,667

(22) PCT Filed: May 21, 2007
(86) PCT No.: PCT/EP2007/054877

§ 371 Date: Nov. 24, 2008

(30) Foreign Application Priority Data
Jun. 2, 2006 (DE) 102006023615.4

(51) Int. Cl. G11B 7/00

(52) U.S. Cl. 720/672; G9B/7

(57) ABSTRACT

The invention relates to a suspension arm actuator for an optical scanning device, comprising a suspension arm designed as a two-arm lever and mounted between the lever arms such that it can be pivoted about an axis extending perpendicularly thereto. On its end side, one of the lever arms supports a scanning head and comprises an articulated region, preferably an elastically bendable region, for a motion of the scanning head in focusing direction and perpendicular in relation to the pivot plane of the suspension arm. The other lever arm is provided with a component of a magnetic drive for a swivel motion about the axis. In addition, the suspension arm actuator comprises a magnetic drive for moving the optical head in focusing direction. As a result, the suspension arm is designed such that the latter's lever arm that supports the scanning head is designed simply and without any further functional elements and is, therefore, reduced in weight. To achieve this, the magnetic drive for moving the optical head in focusing direction is allocated to the lever arm (II) which comprises a component of the magnetic drive for the swivel motion about the axis. The coils for the magnetic drives are, in particular, designed as printed coils.

The invention relates to a suspension arm actuator for a scanning device having a scanning head, preferably an optical head comprising a focal lens, to be arranged in a device for recording and/or reproducing information.

An actuator which is arranged in an optical scanning device and comprises an optical head having a focal lens is intended for emission of a light beam (laser beam) onto an optical disk designed as an information carrier and for reception of the beam reflected by said optical disk. Therein, the optical disk is supported by a supporting device and is caused to make a rotational motion. The actuator may be designed as a suspension arm actuator with two arms, with the optical head being arranged at a free end thereof. The suspension arm is pivoting about an axis and moves the end with the optical head in the form of an arc in a plane extending in parallel to the recording surface of the optical disk (tracking), while being focusable in vertical direction in relation to this plane with its head (focusing). A suspension arm actuator allows to achieve short times of access to various locations on the recording carrier.

Such suspension arm actuators have, for example, been described in EP-A-0 400 570, in JP-A-5128580 and JP-A-2004227760 as well as in US 2004/0148619 A1.

A magnetic drive allocated to the suspension arm actuator described in JP-A-5128580 drives said suspension arm actuator such that the latter makes a swivel motion about the pivot axis in order to scan an optical disk with the optical head in the form of an arc and in a plane arranged in parallel to said optical disk, wherein said magnetic drive is arranged on the side of said pivot axis that is facing away from said optical head. To achieve this, fine-adjustment is provided by means of a further electrode arrangement. A region of the suspension arm located between the latter's pivot axis and the optical head is formed by an electrostrictive converter plate and enables the head to make a movement that is vertical in relation to the arched track of motion and, therefore, perpendicular to an optical disk. This suspension arm actuator is considered to be to disadvantage in that its layout is also complicated and time-consuming and, in addition, requires high operating voltages.

The suspension arm actuator disclosed in JP-A-200422760, which is pivoted and provided with a drive is, at one of its ends, provided with a leaf spring arrangement securely connected thereto, said leaf spring arrangement supporting the optical head at its free end and being elastically bendable through a further drive in vertical direction to the optical disk. This suspension arm actuator is considered to be to disadvantage in that it fails to be impact-resistant.

The suspension arm actuator described in US 2004/0148619 A1 is also arranged on a support such that it can be pivoted about an axis and comprises a magnetic drive at its end region opposite to its optical head, said magnetic drive being formed of a magnetic arrangement permanently arranged on the support and of a coil arranged on the suspension arm, with control of the operating current of said coil. On the pivot axis side facing away from the magnetic drive, that is on the side of the focal lens, the suspension arm also comprises an elastic region (leaf spring arrangement), which supports the optical head at its free end. On the side of the head, a second magnetic drive formed integrally with the suspension arm and being able of moving the free end and, therefore, the head in focusing direction is allocated to said elastic region which is partially enclosed by the remaining suspension arm. Here, it can be considered to be to disadvantage that the head-sided part (lever arm) of the suspension arm is weight-intensive, so that a swivel motion of the suspension arm about the axis is accompanied by an increased inertia thereof.

The invention aims at designing a suspension arm actuator for a scanning device of the aforementioned type such that the lever arm of said suspension arm actuator, which supports the scanning head, is reduced in weight and designed in a simple manner.

For a suspension arm actuator, this problem is solved by the features of ((translator's note: part of sentence missing)) presented in claim 1. Advantageous embodiments are presented in the subordinate claims.

The invention consists of an actuator suspension arm, which is supported against a support in known manner and is designed in the type of a two-arm lever wherein the support forms, at the same time, a pivot axis for the suspension arm extending perpendicularly thereto. Therein, a lever arm supports a scanning head, preferably an optical head having a focal lens, at its end side and comprises an articulated region, preferably an elastically bending region, which is intended to initiate a motion of the scanning head in a direction extending perpendicularly to the pivot plane of the suspension arm (focusing direction). The other lever arm is provided with a component of a magnetic drive for a swivel motion about the axis (tracking direction). The magnetic drive for the motion of the scanning head perpendicularly to the pivot plane is allocated to the lever arm to which the magnetic drive for the motion of the scanning head in tracking direction is allocated. Advantageously, the coils arranged on the lever arm and provided for the magnetic drive in focusing direction are designed as printed coils; this also applies to the coils for the magnetic drive in tracking direction. As a result, a suspension arm actuator is created with a simplified layout, wherein said suspension arm actuator and, above all, the lever arm thereof supporting the scanning head are reduced in weight, this reducing the inertia of the suspension arm and being accompanied by shorter times of access to various locations on a recording carrier. It is also to advantage that the diversity of components is reduced, this resulting in a reduction of complexity and, in particular, in a minimization of costs.

Preferably, the torsionally stiff suspension arm is designed such that the lever arm supporting the scanning head and comprising an elastically bendable region is connected to a bearing element, preferably a bearing bush, in a non-rotatable manner, wherein said bearing element engages a counter bearing element permanently arranged on the support for the suspension arm and allows a swivel motion about the (bearing or swivel) axis, and such that the other lever arm is securely connected to this lever arm in the region between the scanning head and the elastically bendable region and is designed freely suspended on that side of the bendable region that is facing away from the scanning head. The two magnetic drives of the suspension arm actuator are arranged on the freely suspended lever arm.

Therein, said two magnetic drives are each formed by a permanent magnet securely connected to the support and by printed coils allocated to each of said magnetic drives and arranged on the freely suspended lever arm, wherein at least one coil is allocated to each particular magnet, one of said coils being integrated on the upper side of the lever arm and the other coil being integrated on the bottom side of the lever arm, said coils, once current is passing through, each initiating a swivel motion in a predefined swivel direction (tracking direction) or a motion of the lever arm region provided with the scanning head (focusing direction) about the elastically bendable region. Printed coils can be positioned precisely and enhance the resonance behavior, owing to their higher modulus of elasticity and their characteristic frequencies which are lower than those of traditional coils and are, in addition, within higher frequency ranges. The arrangement of printed coils also allows a reduction in the overall height of the suspension arm actuator.

Advantageously, the elastically bendable region in the lever arm supporting the scanning head is achieved by reducing the thickness thereof, said reduction in thickness being such that the lever arm, despite its secure connection to the freely suspended other lever arm, is rigid without the action of any electromagnetic forces. Herein, the region that is reduced in thickness particularly consists of the same material as the lever arm.

Preferably, the suspension arm is pivoted in its center of gravity. As a result, the suspension arm that is designed rigid and torsionally stiff is impact-resistant.

On that of its sides that is facing away from the scanning head, the freely suspended lever arm is, advantageously, designed in the form of a circular arc, with the center point of the circle being the pivot axis. This optimized design is associated with savings in material and weight and contributes to reducing the inertia of the suspension arm.

Below, the invention will be illustrated by means of a preferred exemplary embodiment. In the related figures:

FIG. 1 is a perspective top view of a suspension arm actuator with a coil and magnet arrangement;

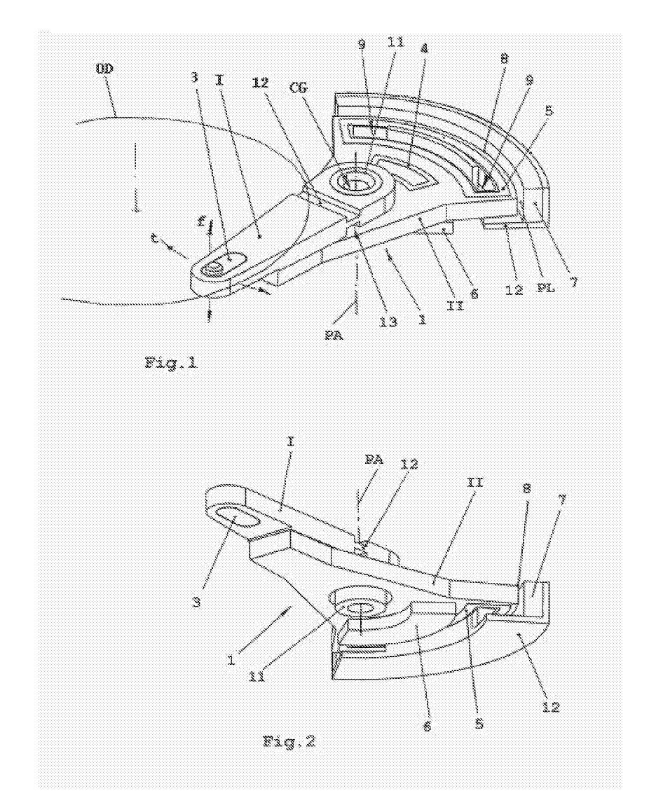

FIG. 2 is a perspective bottom view of the suspension arm actuator;

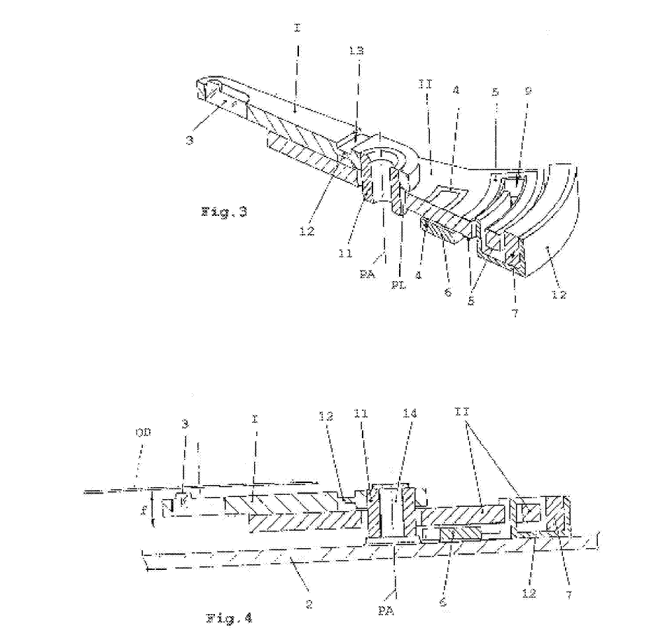

FIG. 3 is a longitudinal sectional view of the suspension arm actuator in perspective; and

FIG. 4 is a longitudinal sectional view of the suspension arm actuator, arranged on a support.

Referring to FIGS. 1 and 2, the suspension arm actuator for an optical scanning device (not shown) comprises a torsionally stiff suspension arm 1 which has a two-arm-lever-type design and is, in its center of gravity CG, mounted to a support (2, FIG. 4) between the lever arms I and II such that it can be pivoted about a pivot axis PA extending perpendicularly to said suspension arm 1. At its end side, the lever arm I supports an optical head 3 having a focal lens. Two printed coil arrangements 4 and 5 which are operably connected to the magnets 6 and 7 and form with these (6, 7) magnetic drives for the suspension arm 1 are arranged on the other lever arm II, said magnets 6 and 7 being permanently arranged on the support and allocated to said coil arrangements 4 and 5. OD presents an optical disk to which the optical head 3 is allocated.

This lever arm II comprises an edge region 8 extending coaxially in relation to the pivot axis and having a coaxially designed recess 9 spaced apart from said edge region 8, said recess 9 being surrounded by a printed coil 5 on each of its upper and bottom sides. A leg of a U-shaped yoke 10 connected to the magnet 7 is engaged in the recess 9 in a non-contacting manner, wherein the magnet 7 itself coaxially encloses the edge region 8 on the latter's outside with play PL. The magnetic drive formed in this manner initiates a motion of the suspension arm 1 perpendicular to the pivot plane in focusing direction (f). In the region between this first magnetic drive and the pivot axis PA, the magnet 6 that has the form of a ring section and is permanently arranged on the support is arranged coaxially in relation to the pivot axis PA and spaced apart from the suspension arm 1. Two coils 4 that are adjusted to the coaxially curved shape of and are corresponding with said magnet 6 are assigned to said magnet 6 as well, wherein one of these coils is arranged on the upper side and the other one on the bottom side of the suspension arm 1. The second magnetic drive that is formed by these coils 4 and said magnet 6 serves to generate a swivel motion of the suspension arm 1 about the pivot axis PA (tracking radiation, radially in relation to an optical disk).

The lever arm I supporting the optical head 3 is connected to a bearing bush 11 in a non-rotatable manner and comprises an elastically bendable region 12 in order to move said head 3 in focusing direction f perpendicularly in relation to the pivot plane. In this region between the optical head 3 and the region 12, the lever arm II is securely connected to this lever arm I, is held exclusively in this region and is, therefore, freely suspended up to its edge region 8 on that side of the bendable region 12 that is facing away from the optical head 3. By means of a groove 13 incorporated on the bottom and upper sides of the lever arm I, the region 12 is considerably reduced as compared with the thickness of this lever arm I and is, in its thickness, designed such that the head-sided part of the otherwise rigid lever arm I is moved in focusing direction (f) once the lever arm II is exposed to the effect of the first magnetic drive formed by the magnet 7. The secure connection of the two lever arms I and II is also used to initiate the swivel motion of the lever arm I about the swivel axis PA as a result of a swivel motion of the lever arm II which is caused by the second magnetic drive formed by the magnet 6, thus initiating a swivel motion of the complete suspension arm 1.

FIG. 3 shows, in particular, the design and arrangement of the magnet 6 and the freely suspended arrangement of the lever arm II, said latter arrangement being characterized by play PL in relation to the bearing bush 11.

FIG. 4 shows the arrangement and bearing support of the suspension 1 on a support 2. A pivot pin 14 is permanently arranged on said support 2, with the suspension arm 1 being pivoted to said pivot pin 14 by means of the bearing bush 11. The optical disk OD allocated to the suspension arm 1 and the optical head 3 thereof is arranged in parallel to said optical head 3. Once the suspension arm 1 makes a swivel motion about the pivot axis PA, the optical head 3 is moved radially in relation to the disk OD (FIG. 1, tracking direction t). Focusing of a specific point on the disk OD is enabled by a motion of the lever arm II and, therefore, of the optical head 5 in focusing direction f, perpendicularly to the tracking direction t.

### LIST OF REFERENCE SYMBOLS

1 Suspension arm
2 Support
3 Optical head
4 Coil
5 Coil
6 Magnet
7 Magnet
8 Edge region
9 Recess
10 Yoke
11 Bearing bush
12 Bendable region
13 Groove
14 Pivot pin
I Lever arm
II Lever arm
f Focusing direction
t Tracking direction
OD Optical disk
CG Center of gravity
PA Pivot axis
PL Play

1-11. (canceled)

12. A suspension arm actuator for a scanning device,
comprising a suspension arm designed as a lever with two-lever arms, the suspension arm being mounted between the two lever arms such that the suspension arm is pivotable about a pivot axis extending perpendicularly thereto,
wherein a first of the lever arms supports at its end side a scanning head and comprises an articulated region intended to initiate a motion of the scanning head perpendicular to the pivot axis, and
wherein the second lever arm is provided with a first magnetic drive for the motion of the scanning head perpendicular to the pivot axis as well as with a component of a second magnetic drive for a swivel motion about the pivot axis, wherein the first magnetic drive is allocated to the second lever arm which comprises the component of the magnetic drive for the swivel motion about the pivot axis.

13. The suspension arm actuator according to claim 12, wherein the first lever arm supporting the scanning head is rigidly connected to a bearing element which enables a swivel motion about the pivot axis and wherein in the region between the scanning head and the articulated region of the first lever arm, the second lever arm is securely connected to the first lever arm and is freely suspended on that side of the region that is facing away from the scanning head.

14. The suspension arm actuator according to claim 13, wherein the articulated region is an elastically bendable region that is reduced in thickness in the longitudinal section of the first lever arm and consists of the same material as the first lever arm.

15. The suspension arm actuator according to claim 13, wherein the suspension arm is mounted in its center of gravity.

16. The suspension arm actuator according to claim 13, wherein the second lever arm comprises on its side facing away from the scanning head an arched edge region, the center of curvature of which is the pivot axis.

17. The suspension arm actuator according to claim 13, wherein the bearing element is a bearing bush which is in pivoting engagement with a pivot pin permanently arranged on the support.

18. The suspension arm actuator according to claim 17, wherein coils for the two magnetic drives are designed as printed coils.

19. The suspension arm actuator according to claim 13, wherein, in order to initiate a focal motion, the first magnetic drive is provided with an arched recess in an end region of the second lever arm, with a leg of a cross-sectionally U-shaped yoke engaging in said recess and a magnet being arranged in and connected to the outer leg of said yoke, and with said recess being surrounded by a printed coil on each of its upper and bottom sides, said coils being designed as focal coils.

20. The suspension arm actuator according to claim 19, wherein the second magnetic drive for the swivel motion of the suspension arm is formed by a magnet permanently arranged on the support and spaced apart from the axis of the suspension arm and by a printed coil arranged on each of the upper and bottom sides of the second lever arm and allocated to said second lever arm, said coils being designed as tracking coils, and that the second magnetic drive is arranged between the first magnetic drive and the pivot axis.

21. The suspension arm actuator according to claim 19, wherein the yoke engaged in the recess at the same time determines the maximum swivel motion of the suspension arm.

22. The suspension arm actuator according to claim 13, wherein said scanning device is an optical scanning device and said scanning head is an optical head having a focal lens, and wherein said suspension arm actuator and said optical scanning device are used in a device for reading and/or writing to optical storage media.
